(19) United States
(12) Patent Application Publication
(10) Pub. No.: US 2008/0084632 A1
(43) Pub. Date: Apr. 10, 2008

(54) Perpendicular magnetic recording medium, production process thereof, and magnetic recording and reproducing apparatus

(75) Inventor: Kenji Shimizu, Chiba-shi (JP)

Correspondence Address: SUGHRUE MION, PLLC, 2100 PENNSYLVANIA AVENUE, N.W., SUITE 800, WASHINGTON, DC, 20037, US

(73) Assignee: Showa Denko K.K., Tokyo (JP)

(21) Appl. No.: 11/664,590

(22) PCT Filed: Oct. 25, 2005
(86) PCT No.: PCT/JP05/19953

§ 371 Date: Apr. 4, 2007

Related U.S. Application Data
(60) Provisional application No. 60/625,117, filed on Nov. 5, 2004.

(30) Foreign Application Priority Data
Oct. 29, 2004 (JP) 2004-315715

(51) Int. Cl. G11B 5/74

(52) U.S. Cl. 360/131

(57) ABSTRACT

A perpendicular magnetic recording medium having an even higher recording density, and a magnetic recording and reproducing apparatus which utilizes the perpendicular magnetic recording medium is provided. The perpendicular magnetic recording medium comprises at least a backing layer, an intermediate layer, a perpendicular magnetic recording film, and a protective film, sequentially formed on a nonmagnetic substrate, wherein the perpendicular magnetic recording film is composed of two layers of different composition comprising a granular structure containing at least Co, Pt and an oxide, and the saturation magnetization (Ms) of a lower perpendicular magnetic recording film provided to a substrate side is smaller than the saturation magnetization (Ms) of an upper recording film provided on the lower perpendicular magnetic recording film to a protective film side.

Priority is claimed to Japanese application No. 2004-315715, filed Oct. 29, 2004, which are incorporated herein by reference. This application also claims the benefit pursuant to 35 U.S.C. § 119 (e) (1) of U.S. Provisional Applications, No. 60/625,117 filed on Nov. 5, 2004.

### TECHNICAL FIELD

The present invention relates to a magnetic recording medium, a production method thereof, and a magnetic recording and reproducing apparatus which uses this magnetic recording medium.

### BACKGROUND ART

A perpendicular magnetic recording method is, conventionally, a suitable method for improving the surface recording density, since it becomes more magnetostatically stable as the recording density becomes higher, which improves the thermal fluctuation tolerance. This is because by orienting the axis of easy magnetization of the magnetic recording medium, which was oriented in the in-plane direction of the medium, in the perpendicular direction, the diamagnetic field near the magnetic transition region, which is the border between the record bits, becomes smaller.

Furthermore, in a case where a backing layer comprising a soft magnetic material is installed between the substrate and the perpendicular magnetic recording film, it functions as a so-called perpendicular 2-layer medium, and a high recording capability can be obtained. At this time, the soft magnetic soft under layer is accomplishing its role of refluxing the recording magnetic field from the magnetic head, and the recording and reproducing efficiency can be improved.

In recent years, as a perpendicular magnetic recording film, oxides added to granular magnetic recording layers have been actively researched. In contrast to a CoCr alloy as this layer, where Cr was segregated to the grain boundary by heating the substrate temperature to a high temperature of 200° C., the granular magnetic recording layer characteristically has the possibility of taking a more segregated structure than a CoCr alloy without heating. (For example, refer to Patent Document 1, and Patent Document 2.)

[Patent Document 1] Japanese Unexamined Patent Application, First Publication No. 2003-178412.

[Patent Document 2] Japanese Unexamined Patent Application, First Publication No. 2004-22138.

### DISCLOSURE OF INVENTION

As mentioned above, perpendicular magnetic recording mediums using various underlayers have been proposed, however these have been insufficient to obtain a magnetic recording medium with an even higher recording density, and a magnetic recording medium which solves this problem and can be easily produced, had been demanded.

The present invention takes into account the abovementioned circumstances, with an object of providing; a magnetic recording medium which can record and reproduce high-density data by making the perpendicular magnetic recording film a layered structure of different compositions, a production method thereof, and a magnetic recording and reproducing apparatus.

In order to solve the above problems, the present invention employs the following configuration. That is to say, the present invention provides the following;

(1) a magnetic recording medium which in a perpendicular magnetic recording medium in which at least a soft under layer, an intermediate layer, a perpendicular magnetic recording film, and a protective film are sequentially formed on a nonmagnetic substrate, is characterized in that the perpendicular magnetic recording film is configured by two layers comprising a granular structure containing at least Co, Pt and an oxide, and the saturated magnetization (Ms) of a lower recording film provided to a substrate side is smaller than the saturated magnetization (Ms) of an upper recording film provided to a protective film side,

(2) a magnetic recording medium according to (1), wherein the saturated magnetization (Ms) of the lower recording film is not greater than 600 (emu/cm³),

(3) a magnetic recording medium according to (1), wherein the saturated magnetization (Ms) of the lower recording film is not less than 150 (emu/cm³) and not greater than 500 (emu/cm³),

(4) a magnetic recording medium according to any one of (1) to (3), wherein the saturated magnetization (Ms) of the upper recording film is not less than 500 (emu/cm³),

(5) a magnetic recording medium according to any one of (1) to (4), wherein the oxide contained in the perpendicular magnetic recording film is any one of SiO₂, Cr₂O₃, Y₂O₃, TiO₂, Ta₂O₅ and SiO,

(6) a magnetic recording medium according to any one of (1) to (5), wherein a nonmagnetic element of the lower recording film other than Co, Pt and the oxide, is not less than 12 (at %) and not greater than 20 (at %),

(7) a magnetic recording medium according to any one of (1) to (6), wherein a nonmagnetic element of the upper recording film other than Co, Pt and the oxide, is less than 12 (at %),

(8) a magnetic recording medium according to any one of (1) to (7), wherein the nonmagnetic element is an element selected from any one of Cr, Ru and Cu,

(9) a magnetic recording medium according to any one of (1) to (8), wherein a nucleation field (-Hn) of the perpendicular magnetic recording film is not less than 1500 (Oe) (120 k/A),

(10) a magnetic recording medium according to any one of (1) to (9), wherein the intermediate film is Ru,

(11) a method of producing a magnetic recording medium which in a method of producing a perpendicular magnetic recording medium comprising at least a soft under layer, an intermediate layer, a perpendicular magnetic recording film, and a protective film sequentially formed on a nonmagnetic substrate, comprises the steps of forming the perpendicular magnetic recording film by two layers comprising a granular structure containing at least Co, Pt and an oxide, forming a perpendicular magnetic recording film with a higher saturated magnetization (Ms) on a substrate side of a lower portion, and then forming a perpendicular magnetic recording film with a lower saturated magnetization (Ms) on a protective film side of an upper portion,

(12) a magnetic recording and reproducing apparatus comprising a magnetic recording medium and a magnetic head which records and reproduces information to the magnetic recording medium, characterized in that the magnetic head is a single magnetic pole head, and the magnetic recording medium according to any one of (1) to (10) is utilized for the magnetic recording medium.

According to the present invention, a magnetic recording medium which in a perpendicular magnetic recording medium in which at least a soft under layer, an intermediate layer, a perpendicular magnetic recording film, and a protective film are sequentially formed on a nonmagnetic substrate, is characterized in that the perpendicular magnetic recording medium is configured by two layers comprising a granular structure containing at least Co, Pt and an oxide, and the saturated magnetization (Ms) of a lower recording film provided to a substrate side is smaller than the saturated magnetization (Ms) of an upper recording film provided to a protective film side. Therefore a magnetic recording medium which can record and reproduce information of a high density, a production method thereof, and a magnetic recording and reproducing apparatus can be provided.

### BRIEF DESCRIPTION OF THE DRAWINGS

FIG. 1 is a diagram showing a cross-sectional construction of a perpendicular magnetic recording medium of the present invention.

FIG. 2 is a diagram showing the construction of a perpendicular recording and reproducing apparatus of the present invention.

### BRIEF DESCRIPTION OF THE REFERENCE SYMBOLS

1 Nonmagnetic substrate, 2 First soft magnetic film, 3 Ru film, 4 Second soft magnetic film, 5 Orientation control film, 6 Intermediate film, 7 Lower magnetic recording film, 8 Upper magnetic recording film, 9 Perpendicular magnetic recording film, 10 Magnetic recording medium. 11 Medium-driving section, 12 Magnetic head, 13 Head drive unit, 14 Recorded/reproduced signal-processing system, 17 Protective film, 18 Lubricant film

### BEST MODE FOR CARRYING OUT THE INVENTION

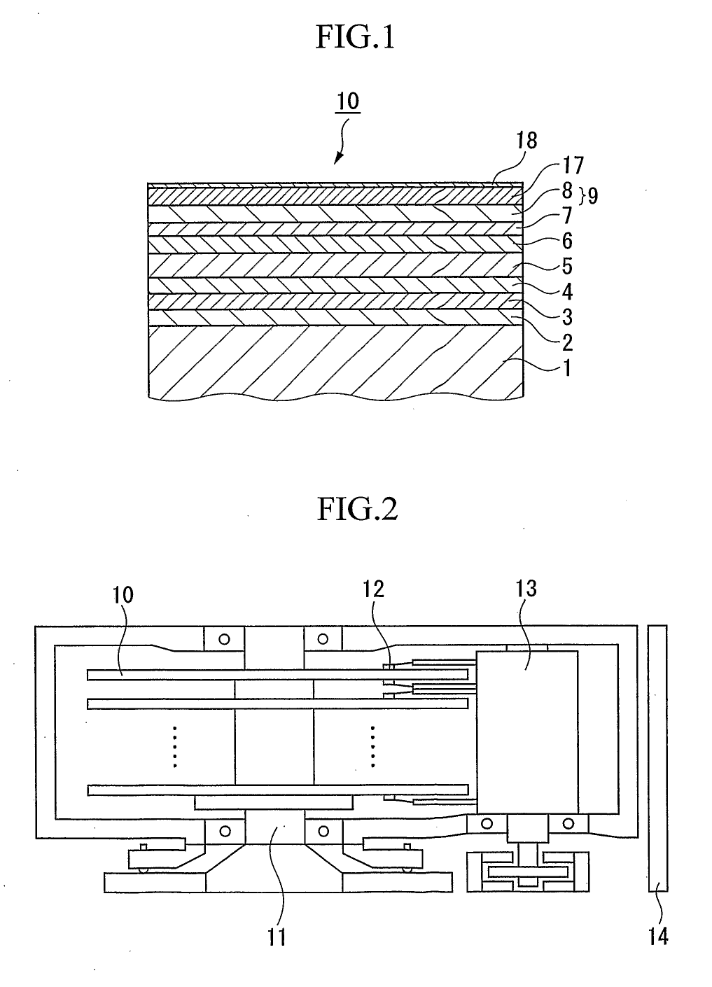

FIG. 1 shows an example of a magnetic recording medium according to the present invention. The magnetic recording medium shown in FIG. 1 is a configuration provided with three layers comprising a first soft magnetic film 2 as a soft under layer, a Ru film 3, and a second soft magnetic film 4, and further provided with an orientation control film 5 and a intermediate film 6, and further provided with a perpendicular magnetic recording film 9 comprising two layers, namely a lower recording film 7- and an upper recording film 8 thereon, and a protective film 17, and a lubricant film 18, which are sequentially formed on a nonmagnetic substrate 1.

As the nonmagnetic substrate, a metallic substrate comprising a metallic material, such as aluminum or aluminum alloy, may be used, or a non-metallic substrate comprising a non-metallic material, such as glass, ceramic, silicon, silicon carbide, or carbon, may be used.

As a glass substrate, there are amorphous glass and crystallized glass, and as amorphous glass, a general purpose soda-lime glass or aluminosilicate glass can be used. Furthermore, as crystallized glass, lithium type crystallized glass can be used.

It is acceptable for the average surface roughness Ra of the nonmagnetic substrate to be made not greater than 0.4 nm, and preferably not greater than 0.3 nm. In a case where the average surface roughness is within the aforementioned range, when deposition of the perpendicular magnetic recording film is performed, further improvements in the characteristics can be obtained. Furthermore, making the average surface roughness Ra not greater than 0.4 nm is preferable from the point of suitability to high recording density recording on which the head is low floating.

Moreover, making the micro-waviness (Wa) not greater than 0.3 nm, still preferably not greater than 0.25 nm, is preferable from the point of suitability to high recording density recording on which the head is low floating.

Of the materials which constitute the soft under layer, the first and second soft magnetic films comprise a soft magnetic material, and as this material, materials containing Fe, Co and Ni can be given. As this material, FeCo alloys (FeCoB, FeCoSiB, FeCoZr, FeCoZrB, FeCoZrBCu, and the like), FeTa alloys (FeTaN, FeTaC, and the like), and Co alloys (CoTaZr, CoZrNB, CoB, and the like) can be given.

It is particularly preferable for the soft magnetic film to be an amorphous structure. This is because by making it an amorphous structure, negative effects, such as expansion of the grain size, and deterioration of the orientation of the undercoat film provided thereon, are not exerted. Furthermore, by making it an amorphous structure, enlargement of the surface roughness Ra is prevented, and it becomes possible to decrease the flying height of the head, and as a result, it becomes possible to further increase the recording density.

The retentivity Hc of the soft magnetic film is not greater than 30 (Oe), and is preferably not greater than 10 (Oe). Moreover 1 (Oe) is approximately 79 A/m.

The saturation magnetic flux density Bs of the soft magnetic film is not less than 1.0 T, and is preferably not less than 1.3 T.

The total film thickness of the soft magnetic film which constitutes the soft under layer, is not less than 20 nm and not greater than 120 nm, and is preferably not less than 30 nm and not greater than 100 nm. If the total film thickness of the soft magnetic film is less than 20 nm, the OW characteristic decreases, which is undesirable. Furthermore, if 120 nm is exceeded, productivity is significantly deteriorated, which is undesirable.

As a formation method of the soft magnetic film, the sputtering method can be used.

At the time of formation of the soft under layer, it is also possible to deposit in a state where a magnetic field is applied in the radial direction.

It is preferable to configure the soft under layer with at least a Ru film, or a Re film, provided between the two soft magnetic films. By providing a Ru film, or a Re film between the soft magnetic films, and setting to a predetermined thickness, it is possible to antiferromagnetically bind the soft magnetic films which are provided above and below. By having such a configuration, it becomes possible to further improve the WATE (Wide Area Track Erasure) phenomenon, which is a problem unique to perpendicular mediums.

The orientation control film is a material for controlling the orientation, the crystal size, and the like, of the perpendicular magnetic recording film installed above. It is preferable for the material used for the orientation control film to be a crystalline structure which has a hcp or a fcc structure. If the structure is one other than the fcc structure (for example, a bcc structure or an amorphous structure), the orientation of the perpendicular magnetic recording film becomes insufficient, and as a result, a decrease in the SNR, and a decrease in the retentivity, is generated, which is undesirable.

As the orientation control film, Pt, Pd, NiCr, NiFeCr, and the like are preferable examples. It is preferable for the film thickness of the orientation control film to be not less than 1 (nim) and not greater than 12 (mm). If the orientation control film is less than 1 nm, the effect as an orientation control film becomes insufficient, and the effect of miniaturization of the grain size is not obtained, and an improvement of orientation is not obtained, which is undesirable. Furthermore, if the thickness of the orientation control film exceeds 12 (nm), the distance between the magnetic head and the soft magnetic soft under layer at the time of recording and reproducing becomes larger. Therefore the OW characteristic, and the resolution of the reproductive signal decreases, which is undesirable.

As the intermediate film, it is preferable to use Ru. As the intermediate film, an additional element may be added for the purpose of improving the grain size miniaturization and orientation.

It is preferable for the film thickness of the intermediate film to be not less than 3 (nm) and not greater than 25 (nm). When the undercoat film is less than 3 (nm), crystal growth becomes insufficient, and the effect as an undercoat film becomes insufficient, which is undesirable. Furthermore, when the thickness of the undercoat film exceeds 25 (nm), the distance between the magnetic head and the soft magnetic soft under layer at the time of recording and reproducing becomes larger. Therefore the OW characteristic, and the resolution of the reproductive signal decreases, which is undesirable.

The perpendicular magnetic recording film has an axis of easy magnetization in the perpendicular direction with respect to the substrate side. As constituent elements, at least Co, Pt and an oxide is included, and furthermore, elements such as Cr, B, Cu, Ta, Zr, and Mn can be added for purposes such as SNR characteristic improvement.

As the oxide which constitutes the perpendicular magnetic recording film, SiO₂, Cr₂O₃, Y₂O₃, TiO₂, Ta₂O₅, SiO, and the like are preferable examples. It is preferable for the volume fraction of the oxide to be 15 to 40 volume %. If the volume fraction of the oxide is less than 15 volume %, it is undesirable because the SNR characteristic becomes insufficient. If the volume fraction of the oxide exceeds 40 volume %, it is undesirable because a retentivity which corresponds to a high recording density cannot be obtained.

It is preferable for the thickness of the perpendicular magnetic recording film to be 8 to 18 nm. If the thickness of the oxide granular layer is within this range, it is preferable because a sufficient output can be secured, and a deterioration of the OW characteristic is not generated.

The perpendicular magnetic recording film utilized in the present invention has a so-called granular structure, which possesses a structure in which the peripheries of the magnetic crystal grains are surrounded by a nonmagnetic nonmetallic material. In the granular magnetic layer, because the grain boundary phase of the nonmagnetic nonmetal physically separates the magnetic particles, the magnetic interactions between the magnetic particles decrease, and the formation of zig-zag magnetic domain walls generated in the transition region of the recording bits is controlled. Therefore, a low noise characteristic can be obtained. Furthermore, in such a granular magnetic recording layer, the nonmagnetic nonmetal material which is used as a grain boundary phase can decrease the interactions between the magnetic particles.

The perpendicular magnetic recording film of the present invention comprises a lower recording film and an upper recording film constituting a laminated structure, and it is preferable for the saturated magnetization (Ms) of the lower recording film to be smaller than the saturated magnetization (Ms) of the upper recording film. By configuring them in this order, it is compatible to achieve high nucleation field (-Hn) as well as low SNR.

It is preferable for the saturated magnetization (Ms) of the lower recording film to be not greater than 600 (emu/cm³). In particular, it is preferable for it to be in the range of not less than 150 (emu/cm³) and not greater than 500 (emu/cm³). A magnetic recording medium of this range shows a particularly excellent SNR. It is preferable for the saturated magnetization (Ms) of the upper recording film to be not less than 500 (emu/cm³). If it is below this, it is undesirable because the nucleation field (-Hn) decreases.

It is preferable for the nonmagnetic element other than Co, Pt and the oxide, which is a constituent element of the lower recording film, to be not less than 12 (at %) and not greater than 20 (at %). By making it in this range, it is possible to obtain an optimal saturated magnetization (Ms) and a SNR which corresponds to a high recording density.

It is preferable for the nonmagnetic element other than Co, Pt and the oxide, which is a constituent element of the lower recording film, to be less than 12 (at %). By making it in this range, it is possible to obtain an optimal saturated magnetization (Ms), a SNR which corresponds to a high recording density, and a high reverse magnetic domain generating field (-Hn).

It is preferable for the nonmagnetic element which constitutes the lower recording film and the upper recording film to comprise any one of Cr, Ru, and Cu. This makes it possible to sufficiently promote the segregated structure of the oxide, and form an excellent granular structure.

It is preferable for the reverse magnetic domain generating field (-Hn) of the perpendicular magnetic recording film to be not less than 1500 (Oe). If the reverse magnetic domain generating field (-Hn) is less than 1500 (Oe), the thermal fluctuation tolerance considerably decreases, which is undesirable.

The protective film, as well as preventing the corrosion of the perpendicular magnetic recording film, is a material which prevents damage to the medium surface when the magnetic head comes into contact with the medium, and a conventionally known material can be utilized. For example, it is possible to utilize a material containing C, SiO₂, or ZrO₂. By making the thickness of the protective film not less than 1 nm, and not greater than 5 nm, the distance between the head and the medium can be made small, which is preferable from the point of high recording density.

For the lubricant film, it is preferable to use a conventionally known material, for example, a perfluoropolyether, a fluorinated alcohol, a fluorinated carboxylic acid, and the like.

The magnetic recording medium of the present aspect which comprises a perpendicular magnetic recording medium comprising at least a soft under layer, an intermediate layer, a perpendicular magnetic recording film, and a protective film are sequentially formed on a nonmagnetic substrate, is characterized in that the perpendicular magnetic recording medium is configured by two layers comprising a granular structure containing at least Co, Pt and an oxide, and the saturated magnetization (Ms) of the lower recording film 1 provided to the substrate side is smaller than the saturated magnetization (Ms) of the upper recording film 2 provided to the protective film side. Therefore recording and reproduction of information of a high density becomes possible.

FIG. 2 shows an example of a magnetic recording and reproducing apparatus using the aforementioned magnetic recording medium. The magnetic recording and regenerative apparatus shown here is furnished with the aforementioned magnetic recording medium 10 of the present invention, a medium-driving section 11 which rotates the magnetic recording medium 10, a magnetic head 12 which records and reproduces information from the magnetic recording medium 10, a head-driving section 13, and a recorded/reproduced signal-processing system 14. The recorded/reproduced signal-processing system 14 is able to process the input data and send the record signal to the magnetic head 12, or process the reproduced signal from the magnetic head 12 and output the data.

### EXAMPLES

Hereunder, examples are shown to clarify the operational effects of the present invention. However, the present invention is not limited to the following examples.

### Example 1

A glass substrate (amorphous substrate MEL product of MYG, diameter 2.5 inch), was accommodated inside the deposition chamber of a DC magnetron sputter apparatus (Aneruva Corp., C3010), and the inside of the deposition chamber was evacuated until a vacuum level of 1×10⁻⁵ was obtained. After substrate heating was performed, a soft under layer was formed by depositing 50 nm of 89Co-4Zr-7Nb (Co content 89 at %, Zr content 4 at %, Nb content 7 at %) as a first soft magnetic film, 0.8 nm of a Ru film which is to be placed in between the layers, and 50 nm of 89Co-4Zr-7Nb as a second soft magnetic film, on this substrate. The crystalline structure of the soft under layer was confirmed to be the amorphous structure by XRD.

Next, 5 nm of 60Ni-35Cr-5B as an orientation control film, 15 nm of Ru as an undercoat film, and 4 nm of 60Co-15Cr-15Pt-10SiO₂ and 8 nm of 70Co-5Cr-15Pt-10SiO₂ as a perpendicular magnetic recording film, was deposited. The saturated magnetization (Ms) of the 60Co-15Cr-15Pt-10SiO₂ of 250 (emu/cm³), and the saturated magnetization (Ms) of the 70Co-5Cr-15Pt-10SiO₂ of 680 (emu/cm³), were separately confirmed by a vibrating sample magnetometer (VSM). Next, a protective film of 4 nm was formed by the CVD method.

Next, a lubricant film comprising a perfluoropolyether was formed by the dipping method, and the perpendicular magnetic recording medium was obtained.

### Comparative Examples 1 to 4

Other than changing the configuration of the perpendicular magnetic recording film, the magnetic recording medium was made as for Example 1.

The recording and reproducing characteristics were evaluated with regard to magnetic recording mediums of these Examples and Comparative Examples. The evaluation of the recording and reproducing characteristics was determined using a USA GUZIK Co. read/write analyzer RWA1632 and a spin-stand S1 701 MP.

The evaluation of the recording and reproducing characteristics was determined by utilizing a magnetic head using a single pole magnetic pole for writing, and a GMR element in the reproducing section, and the recording frequency condition was made to be a track recording density of 900 kFCI. The evaluation results are shown in Table 1. The magnetostatic characteristics were determined using a Kerr Effect Measurement Apparatus (product of Neoarc).

TABLE 1

| | LOWER RECORDING FILM | | | |
|---|---|---|---|---|
| | | FILM | SATURATION | UPPER RECORDING FILM |
| | COMPOSITION | THICKNES | AGNETIZATIO | COMPOSITION |
| | (at %) | (nm) | (emu/cm3) | (at %) |
| EXAMPLE1 | 60Co—15Cr—15Pt—10SiO2 | 4 | 250 | 70Co—5Cr—15Pt—10SiO2 |
| COMPARATIVE | 60Co—15Cr—15Pt—10SiO2 | 12 | 250 | |
| EXAMPLE1 | | | | |
| COMPARATIVE | 70Co—5Cr—15Pt—10SiO2 | 12 | 680 | |
| EXAMPLE2 | | | | |
| COMPARATIVE | 70Co—5Cr—15Pt—10SiO2 | 8 | 680 | 60Co—15Cr—15Pt—10SiO2 |
| EXAMPLE3 | | | | |
| COMPARATIVE | 65Co—10Cr—15Pt—10SiO2 | 4 | 500 | 63Co—12Cr—15Pt—10SiO2 |
| EXAMPLE4 | | | | |

| | UPPER RECORDING FILM | | | OPPOSING MANETIC | |
|---|---|---|---|---|---|
| | FILM | SATURATION | COERCIVE | DOMAIN FORMING | |
| | THICKNES | AGNETIZATIO | FORCE | MAGNETIC FIELD | SNR |
| | (nm) | (emu/cm3) | (Oe) | (Oe) | (dB) |
| EXAMPLE1 | 8 | 680 | 4800 | 1950 | 25.8 |
| COMPARATIVE | | | 2500 | — | 23.8 |
| EXAMPLE1 | | | | | |
| COMPARATIVE | | | 5020 | 2000 | 22.8 |
| EXAMPLE2 | | | | | |
| COMPARATIVE | 4 | 250 | 4280 | 840 | 24.1 |
| EXAMPLE3 | | | | | |
| COMPARATIVE | 8 | 400 | 4880 | 1880 | 23.5 |
| EXAMPLE4 | | | | | |

In comparison to Comparative Examples 1 to 4, a superior SNR was confirmed in Example 1. Furthermore, it can be understood that there is no decrease in the opposing magnetic domain forming field (-Hn), and no problem in the thermal fluctuation resistance.

### Examples 2 to 6

Other than changing the composition of the lower recording film as in Table 2, the magnetic recording medium was made as for Example 1. The evaluation results are shown in Table 2.

TABLE 2

| | LOWER RECORDING FILM | | | |
|---|---|---|---|---|
| | | FILM | SATURATION | UPPER RECORDING FILM |
| | COMPOSITION | THICKNESS | MAGNETIZATION | COMPOSITION |
| | (at %) | (nm) | (emu/cm³) | (at %) |
| EXAMPLE1 | 60Co—15Cr—15Pt—10SiO₂ | 4 | 250 | 70Co—5Cr—15Pt—10SiO₂ |
| EXAMPLE2 | 50Co—25Cr—15Pt—10SiO₂ | 4 | 20 | 70Co—5Cr—15Pt—10SiO₂ |
| EXAMPLE3 | 55Co—20Cr—15Pt—10SiO₂ | 4 | 150 | 70Co—5Cr—15Pt—10SiO₂ |
| EXAMPLE4 | 57Co—18Cr—15Pt—10SiO₂ | 4 | 200 | 70Co—5Cr—15Pt—10SiO₂ |
| EXAMPLE5 | 63Co—12Cr—15Pt—10SiO₂ | 4 | 400 | 70Co—5Cr—15Pt—10SiO₂ |
| EXAMPLE6 | 65Co—10Cr—15Pt—10SiO₂ | 4 | 500 | 70Co—5Cr—15Pt—10SiO₂ |

| | UPPER RECORDING FILM | | | OPPOSING MANETIC | |
|---|---|---|---|---|---|
| | FILM | SATURATION | COERCIVE | DOMAIN FORMING | |
| | THICKNESS | MAGNETIZATION | FORCE | MAGNETIC FIELD | SNR |
| | (nm) | (emu/cm³) | (Oe) | (Oe) | (dB) |
| EXAMPLE1 | 8 | 680 | 4800 | 1950 | 25.8 |
| EXAMPLE2 | 8 | 680 | 4700 | 1600 | 24.8 |
| EXAMPLE3 | 8 | 680 | 4860 | 1730 | 25.5 |
| EXAMPLE4 | 8 | 680 | 4820 | 1840 | 25.3 |
| EXAMPLE5 | 8 | 680 | 4900 | 2010 | 25.1 |
| EXAMPLE6 | 8 | 680 | 4900 | 2010 | 24.6 |

It was possible to obtain a superior SNR and a reverse magnetic domain generating field (-Hn) in examples where the saturated magnetization (Ms) of the lower recording film was lower than the saturated magnetization (Ms) of the upper recording film. In particular, it was possible to obtain excellent characteristics in examples where the saturated magnetization (Ms) of the lower recording film was not less than 150 (emu/cm³) and not greater than 500 (emu/cm³).

### Examples 7, 8

Other than changing the composition of the upper recording film as shown in Table 3, the magnetic recording medium was made as for Example 1. The evaluation results are shown in Table 3.

TABLE 3

| | LOWER RECORDING FILM | | | |
|---|---|---|---|---|
| | | FILM | SATURATION | UPPER RECORDING FILM |
| | COMPOSITION | THICKNESS | MAGNETIZATION | COMPOSITION |
| | (at %) | (nm) | (emu/cm³) | (at %) |
| EXAMPLE1 | 60Co—15Cr—15Pt—10SiO₂ | 4 | 250 | 70Co—5Cr—15Pt—10SiO₂ |
| EXAMPLE7 | 60Co—15Cr—15Pt—10SiO₂ | 4 | 250 | 65Co—10Cr—15Pt—10SiO₂ |
| EXAMPLE8 | 60Co—15Cr—15Pt—10SiO₂ | 4 | 250 | 63Co—12Cr—15Pt—10SiO₂ |

| | UPPER RECORDING FILM | | | OPPOSING MANETIC | |
|---|---|---|---|---|---|
| | FILM | SATURATION | COERCIVE | DOMAIN FORMING | |
| | THICKNESS | MAGNETIZATION | FORCE | MAGNETIC FIELD | SNR |
| | (nm) | (emu/cm³) | (Oe) | (Oe) | (dB) |
| EXAMPLE1 | 8 | 680 | 4800 | 1950 | 25.8 |
| EXAMPLE7 | 8 | 500 | 4660 | 1750 | 25.9 |
| EXAMPLE8 | 8 | 400 | 4480 | 1550 | 25.3 |

It was possible to obtain a superior SNR and a reverse magnetic domain generating field (-Hn) in examples where the saturated magnetization (Ms) of the lower recording layer was lower than the saturated magnetization (Ms) of the upper recording film. In particular, it was possible to obtain excellent characteristics in examples where the saturated magnetization (Ms) of the upper recording film was not less than 500 (emu/cm³).

### Examples 9 to 12

Other than changing the thickness of the upper recording film and the lower recording film as shown in Table 4, the magnetic recording medium of Example 9 to 12 was prepared by the same method as for preparing the sample of Example 1. The evaluation results are shown in Table 4.

In each of the magnetic recording mediums, superior characteristics could be obtained.

TABLE 4

| | LOWER RECORDING FILM | | | |
|---|---|---|---|---|
| | | FILM | SATURATION | UPPER RECORDING FILM |
| | COMPOSITION | THICKNESS | MAGNETIZATION | COMPOSITION |
| | (at %) | (nm) | (emu/cm³) | (at %) |
| EXAMPLE1 | 60Co—15Cr—15Pt—10SiO₂ | 4 | 250 | 70Co—5Cr—15Pt—10SiO₂ |
| COMPARATIVE | 60Co—15Cr—15Pt—10SiO₂ | 2 | 250 | 70Co—5Cr—15Pt—10SiO₂ |
| EXAMPLE9 | | | | |
| COMPARATIVE | 60Co—15Cr—15Pt—10SiO₂ | 6 | 250 | 70Co—5Cr—15Pt—10SiO₂ |
| EXAMPLE10 | | | | |
| COMPARATIVE | 60Co—15Cr—15Pt—10SiO₂ | 4 | 250 | 70Co—5Cr—15Pt—10SiO₂ |
| EXAMPLE11 | | | | |
| COMPARATIVE | 60Co—15Cr—15Pt—10SiO₂ | 6 | 250 | 70Co—5Cr—15Pt—10SiO₂ |
| EXAMPLE12 | | | | |

| | UPPER RECORDING FILM | | | OPPOSING MANETIC | |
|---|---|---|---|---|---|
| | FILM | SATURATION | COERCIVE | DOMAIN FORMING | |
| | THICKNESS | MAGNETIZATION | FORCE | MAGNETIC FIELD | SNR |
| | (nm) | (emu/cm³) | (Oe) | (Oe) | (dB) |
| EXAMPLE1 | 8 | 680 | 4800 | 1950 | 25.8 |
| COMPARATIVE | 10 | 680 | 4980 | 2020 | 25.6 |
| EXAMPLE9 | | | | | |
| COMPARATIVE | 6 | 680 | 4790 | 1680 | 25.5 |
| EXAMPLE10 | | | | | |
| COMPARATIVE | 10 | 680 | 5310 | 2200 | 25.5 |
| EXAMPLE11 | | | | | |
| COMPARATIVE | 8 | 680 | 5180 | 1900 | 25.4 |
| EXAMPLE12 | | | | | |

### Examples 13 to 21

Other than changing the constituent element of the perpendicular magnetic recording film as shown in Table 5, the magnetic recording medium was made as for Example 1. The evaluation results are shown in Table 5.

In each of the magnetic recording mediums, superior characteristics could be obtained.

TABLE 5

| | LOWER RECORDING FILM | | | |
|---|---|---|---|---|
| | | FILM | SATURATION | UPPER RECORDING FILM |
| | COMPOSITION | THICKNESS | MAGNETIZATION | COMPOSITION |
| | (at %) | (nm) | (emu/cm³) | (at %) |
| EXAMPLE1 | 60Co—15Cr—15Pt—10SiO₂ | 4 | 250 | 70Co—5Cr—15Pt—10SiO₂ |
| COMPARATIVE | 60Co—10Cr—15Pt—10SiO₂—3Cu | 4 | 250 | 70Co—5Cr—15Pt—10SiO₂ |
| EXAMPLE13 | | | | |
| COMPARATIVE | 60Co—10Cr—15Pt—10SiO₂—5Ru | 4 | 250 | 70Co—5Cr—15Pt—10SiO₂ |
| EXAMPLE14 | | | | |
| COMPARATIVE | 60Co—15Pt—10SiO₂—12Ru | 4 | 250 | 70Co—5Cr—15Pt—10SiO₂ |
| EXAMPLE15 | | | | |
| COMPARATIVE | 60Co—15Cr—15Pt—10SiO₂ | 4 | 250 | 70Co—5Cr—15Pt—10SiO₂—2Cu |
| EXAMPLE16 | | | | |
| COMPARATIVE | 60Co—15Cr—15Pt—10SiO₂ | 4 | 250 | 70Cor-15Pt—10SiO₂—5Cu |
| EXAMPLE17 | | | | |
| COMPARATIVE | 63Co—15Cr—15Pt—7TiO₂ | 4 | 280 | 70Co—5Cr—15Pt—10SiO₂ |
| EXAMPLE18 | | | | |
| COMPARATIVE | 60Co—15Cr—15Pt—5Ta₂O₅ | 4 | 220 | 70Co—5Cr—15Pt—10SiO₂ |
| EXAMPLE19 | | | | |
| COMPARATIVE | 60Co—15Cr—15Pt—10SiO₂ | 4 | 250 | 70Co—5Cr—15Pt—6Y₂O₃ |
| EXAMPLE20 | | | | |
| COMPARATIVE | 60Co—15Cr—15Pt—10SiO₂ | 4 | 250 | 70Co—5Cr—15Pt—5Cr₂O₃ |
| EXAMPLE21 | | | | |

| | UPPER RECORDING FILM | | | OPPOSING MANETIC | |
|---|---|---|---|---|---|
| | FILM | SATURATION | COERCIVE | DOMAIN FORMING | |
| | THICKNESS | MAGNETIZATION | FORCE | MAGNETIC FIELD | SNR |
| | (nm) | (emu/cm³) | (Oe) | (Oe) | (dB) |
| EXAMPLE1 | 8 | 680 | 4800 | 1950 | 25.8 |
| COMPARATIVE | 8 | 680 | 4750 | 1880 | 25.9 |
| EXAMPLE13 | | | | | |
| COMPARATIVE | 8 | 680 | 4960 | 2010 | 26.2 |
| EXAMPLE14 | | | | | |
| COMPARATIVE | 8 | 680 | 4840 | 1900 | 26.1 |
| EXAMPLE15 | | | | | |
| COMPARATIVE | 8 | 620 | 5020 | 2070 | 25.9 |
| EXAMPLE16 | | | | | |
| COMPARATIVE | 8 | 660 | 5180 | 2120 | 26.1 |
| EXAMPLE17 | | | | | |
| COMPARATIVE | 8 | 680 | 4800 | 1950 | 25.8 |
| EXAMPLE18 | | | | | |
| COMPARATIVE | 8 | 680 | 4790 | 1780 | 26.1 |
| EXAMPLE19 | | | | | |
| COMPARATIVE | 8 | 660 | 4870 | 1890 | 25.9 |
| EXAMPLE20 | | | | | |
| COMPARATIVE | 8 | 640 | 4900 | 1970 | 25.7 |
| EXAMPLE21 | | | | | |

FIG. 2 shows an example of a magnetic recording and reproducing apparatus using the aforementioned magnetic recording medium. The magnetic recording and reproducing apparatus shown here is furnished with the aforementioned magnetic recording medium 10 of the present invention, a medium-driving section 11 which rotates the magnetic recording medium 10, a magnetic head 12 which records and reproduces information from the magnetic recording medium 10, a head-driving section 13, and a recorded/reproduced signal-processing system 14. The recorded/reproduced signal-processing system 14 is able to process the input data and send the record signal to the magnetic head 12, or process the reproduced signal from the magnetic head 12 and output the data.

A magnetic recording and reproducing apparatus with the construction shown in FIG. 2, and utilizing magnetic recording mediums obtained as mentioned above, was assembled.

The magnetic recording and reproducing apparatus of the present invention was superior in SNR characteristics and OW characteristics, and was a magnetic recording and reproducing apparatus in which recording and reproducing of high density information was possible.

1. A perpendicular magnetic recording medium comprising at least a backing layer, an intermediate layer, a perpendicular magnetic recording film, and a protective film, sequentially formed on a nonmagnetic substrate, wherein said perpendicular magnetic recording film is composed by two layers comprising a granular structure containing at least Co, Pt and an oxide, and the saturation magnetization (Ms) of a lower perpendicular magnetic recording film provided to a substrate side is smaller than the saturation magnetization (Ms) of an upper perpendicular magnetic recording film provided to a protective film side.

2. The magnetic recording medium according to claim 1, wherein the saturation magnetization (Ms) of said lower perpendicular magnetic recording film is not greater than 600 (emu/cm³).

3. The magnetic recording medium according to claim 1, wherein the saturation magnetization (Ms) of said lower perpendicular magnetic recording film is not less than 150 (emu/cm³) and not greater than 500 (emu/cm³).

4. The magnetic recording medium according to claim 1, wherein the saturation magnetization (Ms) of said upper perpendicular magnetic recording film is not less than 500 (emu/cm³).

5. The magnetic recording medium according to claim 1, wherein the oxide contained in said perpendicular magnetic recording film is any one selected from the group consisting of SiO₂, Cr₂O₃, Y₂O₃, TiO₂, Ta₂O₅ and SiO.

6. The magnetic recording medium according to claim 1, wherein a content of a nonmagnetic element in said lower perpendicular magnetic recording film other than Co, Pt and the oxide, is not less than 12 at % and not greater than 20 at %.

7. The magnetic recording medium according to claim 1, wherein the content of a nonmagnetic element of said upper recording film other than Co, Pt and the oxide, is less than 12 at %.

8. The magnetic recording medium according to claim 6, wherein said nonmagnetic element is an element selected from any one of Cr, Ru and Cu.

9. The magnetic recording medium according to claim 1, wherein a reverse magnetic domain nucleation field (-Hn) of said perpendicular magnetic recording film is not less than 1500 (Oe) (120 k/A).

10. A magnetic recording medium according to claim 1, wherein said intermediate film is Ru.

11. A method of producing a perpendicular magnetic recording medium comprising at least a backing layer, an intermediate layer, a perpendicular magnetic recording film, formed by two layers comprising a lower layer and an upper layer having a granular structure containing Pt, Co, and an oxide, and a protective film sequentially formed on a nonmagnetic substrate, comprising the steps of:
forming the lower layer of the perpendicular magnetic recording film with a higher saturation magnetization (Ms) on a substrate side, and subsequently forming the upper layer of the perpendicular magnetic recording film with a lower saturation magnetization (Ms) on the lower layer of the perpendicular magnetic recording film.

12. A magnetic recording and reproducing apparatus comprising a magnetic recording medium and a magnetic head which records and reproduces information to said magnetic recording medium, wherein the magnetic head is a single magnetic pole head, and the magnetic recording medium according to claim 1 is utilized for the magnetic recording medium.

13. The magnetic recording medium according to claim 7, wherein said nonmagnetic element is an element selected from any one of Cr, Ru and Cu.
